(19) United States
(12) Patent Application Publication
(10) Pub. No.: US 2019/0057481 A1
(43) Pub. Date: Feb. 21, 2019

(54) SYSTEM AND METHOD FOR PROCESSING SIMULTANEOUS CARPOOL REQUESTS

(71) Applicant: BEIJING DIDI INFINITY TECHNOLOGY AND DEVELOPMENT CO., LTD., Beijing (CN)

(72) Inventors: Niping ZHANG, Beijing (CN); Lu LI, Beijing (CN); Mingshan LUO, Beijing (CN); Pumeng WEI, Beijing (CN); Meichen LIU, Beijing (CN)

(73) Assignee: BEIJING DIDI INFINITY TECHNOLOGY AND DEVELOPMENT CO., LTD., Beijing (CN)

(21) Appl. No.: 15/858,959

(22) Filed: Dec. 29, 2017

(30) Foreign Application Priority Data
Aug. 16, 2017 (CN) 201710701159.X

(51) Int. Cl. G06Q 50/30; G06Q 10/06; G06Q 10/04; G01C 21/34

(52) U.S. Cl. CPC G06Q 50/30; G06Q 10/06315; H04W 4/023; G01C 21/3438; G06Q 10/047

(57) ABSTRACT

A computer-implemented method for providing transportation service is described. The method can include receiving a first transportation service request from a user terminal device. The method can further include determining, by a processor, an estimated time for the first transportation service request to be fulfilled. The method can also include determining, by the processor, a hypothetical time for the first transportation service request to be fulfilled if switching to a carpool request. The method can also include providing, to the user terminal device, a recommendation to switch to the carpool request when the hypothetical time is less than the estimated time. The method can also include providing a carpool service to fulfill the first transportation service request when an acceptance of the recommendation is received from the user terminal device.

### CROSS REFERENCE TO RELATED APPLICATION

The present application is based on and claims the benefits of priority to Chinese Application No. 201710701159.X, filed Aug. 16, 2017, the entire contents of which are incorporated herein by reference.

### TECHNICAL FIELD

The present disclosure relates to methods and systems for carpooling. More particularly, the disclosure relates to methods and systems for processing simultaneous carpool requests.

### BACKGROUND

An online platform may be used to match drivers who can offer car rides and passengers who need transportation services. After a service request is received from a passenger, a driver will be dispatched to pick the passenger up and fulfill the request. Carpooling is a way to share a car ride so that one driver provides transportation service to multiple passengers simultaneously. Thus, carpooling may help balance supply and demand, and reduce costs and carbon emissions.

However, when demand substantially exceeds supply, i.e., a lot more passengers requesting carpooling compared to the available service vehicles, the carpooling requests cannot be processed immediately due to limits of server processing capability. A large amount of computations are involved to process a carpooling request, including dynamically determining the trip route and matching that with multiple carpooling requests. As a result, a waiting time will occur, which impairs customer experience.

The disclosed systems and methods are designed to address at least the above discussed issues.

### SUMMARY

Embodiments of disclosure provide a computer-implemented method for providing transportation service. The method can include receiving a first transportation service request from a user terminal device. The method can further include determining, by a processor, an estimated time for the first transportation service request to be fulfilled. The method can also include determining, by the processor, a hypothetical time for the first transportation service request to be fulfilled if switching to a carpool request. The method can also include providing, to the user terminal device, a recommendation to switch to a carpool request when the hypothetical time is less than the estimated time. The method can also include providing a carpool service to fulfill the first transportation service request when an acceptance of the recommendation is received from the user terminal device.

Embodiments of the disclosure further provide a system for providing transportation service. The system includes a memory, a communication interface, and at least one processor coupled to the communication interface and the memory. The communication interface may be configured to receive a first transportation service request from a user terminal device. The at least one processor may be configured to determine an estimated time for the first transportation service request to be fulfilled. The at least one processor may also be configured to determine a hypothetical time for the first transportation service request to be fulfilled if switching to a carpool request. The at least one processor may also be configured to provide, to a user terminal device, a recommendation to switch to the carpool request when the hypothetical time is less than the estimated time. The at least one processor may also be configured to provide a carpool service to fulfill the first transportation service request when an acceptance of the recommendation is received from the user terminal device.

Embodiments of the disclosure further provide a non-transitory computer-readable medium that stores a set of instructions, when executed by at least one processor of an electronic device, cause the electronic device to perform a method for providing transportation service. The method includes receiving a first transportation service request from a user terminal device. The method also includes determining, by a processor, an estimated time for the first transportation service request to be fulfilled. The method also includes determining, by the processor, a hypothetical time for the first transportation service request to be fulfilled if switching to a carpool request. The method also includes providing, to the user terminal device, a recommendation to switch to the carpool request when the hypothetical time is less than the estimated time. The method also includes providing a carpool service to fulfill the first transportation service request when an acceptance of the recommendation is received from the user terminal device.

### BRIEF DESCRIPTION OF DRAWINGS

The accompanying drawings, which comprise a part of this specification, illustrate several embodiments and, together with the description, serve to explain the disclosed principles.

FIG. 1 illustrates a schematic diagram of an exemplary system 100 for providing transportation service, consistent with disclosed embodiments.

FIG. 2 is a flowchart of an exemplary method for processing simultaneous carpool requests, consistent with disclosed embodiments.

FIG. 3 is a flowchart of an exemplary method for matching two transportation service requests.

FIG. 4 illustrates an exemplary method for processing simultaneous carpool request, consistent with disclosed embodiments.

FIG. 5 illustrates an exemplary user interface on a terminal device, consistent with disclosed embodiments.

FIG. 6 illustrates another exemplary user interface on a terminal device, consistent with disclosed embodiments.

### DETAILED DESCRIPTION

The disclosed embodiments relate to systems and methods for processing simultaneous carpool request. Embodiments of the present disclosure may be implemented using specialized logic circuits or using generic processors, e.g., in a server, a terminal device, a communication device embedded in the car, a kiosk device, and etc.

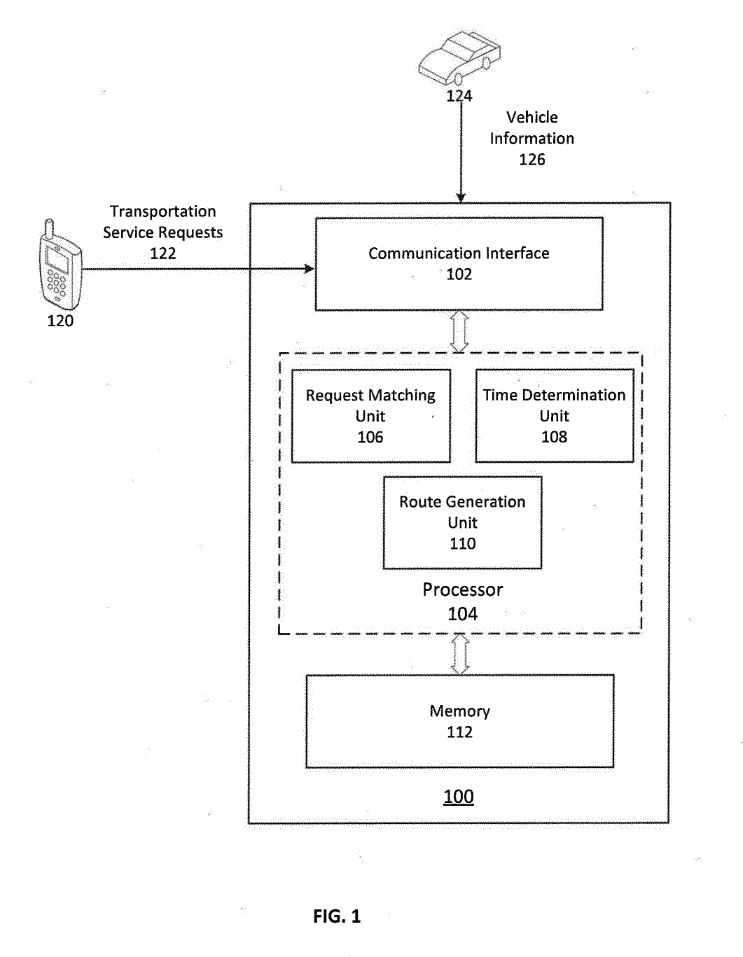

FIG. 1 illustrates a schematic diagram of an exemplary system 100 for providing transportation service, according to embodiments of the disclosure.

System 100 can be a general-purpose server or a proprietary device specially designed for providing transportation service. It is contemplated that, system 100 can be a separate system (e.g., a server) or an integrated component of a server. Because processing transportation service may require significant computation resources, in some embodiments, system 100 may be preferably implemented as a separate system. In some embodiments, system 100 may include sub-systems, some of which may be remote.

In some embodiments, as shown in FIG. 1, system 100 may include a communication interface 102, a processor 104, and a memory 112. Processor 104 may further include multiple modules, such as a request matching unit 106, a time determination unit 108, a route generation unit 110, and the like. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more functions. Although FIG. 1 shows units 106-110 all within one processor 104, it is contemplated that these units may be distributed among multiple processors located near or remotely with each other. In some embodiments, system 100 may be implemented in the cloud, or on a separate computer/server.

Communication interface 102 may be configured to receive a transportation service request 122 from a user terminal device 120 in an area, and receive vehicle information 126 of at least one service vehicle 124 from the at least one service vehicle 124 in the area. User terminal device 120 can be any suitable device that can interact with a passenger, e.g., a smart phone, a tablet, a wearable device, a computer, or the like. Transportation service request 122 can include a current location of the passenger, an origin and a destination of the requested transportation service, a request time, a number of passengers or the like. The origins and destinations may be described using address and/or coordinates. System 100 can generate an estimated price and send the estimated price back to the terminal for displaying to the passenger. System 100 can also determine an estimated wait time and send the estimated wait time back to the terminal for displaying to the user. Vehicle information 126 of the at least one service vehicle, e.g., vehicle 124, can also be received by communication interface 102. The service vehicles can include taxi cars and private cars that are connected to the online hailing platform. It is contemplated that, the service vehicles can also be autonomous vehicles. Vehicle information 126 can include at least one of locations, capacities, current driving directions, vehicle models, or other features of the service vehicles.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

In some embodiments, request matching unit 106 can be configured to match two transportation service requests in the queue for a carpool service. For example, request matching unit 106 may match the first and second transportation service requests, when the difference between the estimated time for the first transportation service request to be fulfilled and the hypothetical time based on a position of the second transportation service request in the queue is no greater than a predetermined value.

In some embodiments, time determination unit 108 can be configured to predict an estimated wait time for a transportation service request to be fulfilled. Further, time determination unit can be configured to determine a hypothetical time for a transportation service request to be fulfilled if switching to a carpool request.

In some embodiments, route generation unit 110 can be configured to determine an estimated route based on a transportation service request, and determine a hypothetical route based on the transportation service request to be fulfilled if switching to a carpool request.

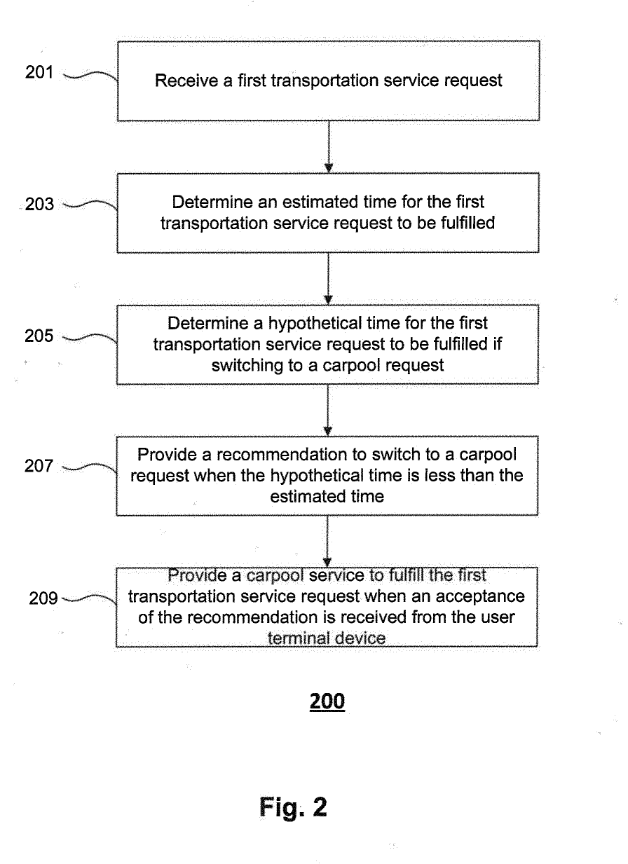

FIG. 2 is a flowchart of an exemplary method for processing simultaneous carpool requests, consistent with disclosed embodiments. At step 201, communication interface 102 may receive a first transportation service request (e.g., transportation service request 122) from a user terminal device 120. At step 203, time determination unit 108 may determine an estimated time for the first transportation service request to be fulfilled. To determine an estimated time, processor 104 may place the transportation service request in a queue. Then, based on the transportation service request, the vehicle information, and a position in a queue, time determination unit 108 may determine an estimated time for the first transportation service request to be fulfilled.

In some embodiments, the estimated time may include an estimated wait time for the transportation service request to be processed and an estimated trip time for fulfilling the transportation service request. In some embodiments, the estimated time for the transportation service request to be fulfilled can be determined based on historical data associated with the queue. For example, time determination unit 108 can determine the estimated time using machine learning, techniques. Time determination unit 108 can train a machine learning model, based on the sample data and the supervised signal. The historical data can include sample data and corresponding supervised signal. The sample data can include an origin, a destination, a request time, a location, a position in a waiting queue, a number of previous requests in the waiting queue of a historical request. The supervised signal can include the actual time for fulfilling a transportation service request of the historical request. The trained model can be further used to estimate the waiting time according to features of a transportation service request. It is contemplated that, time determination unit 108 can continuously determine the estimated time during the whole queuing process, to periodically update the estimated time.

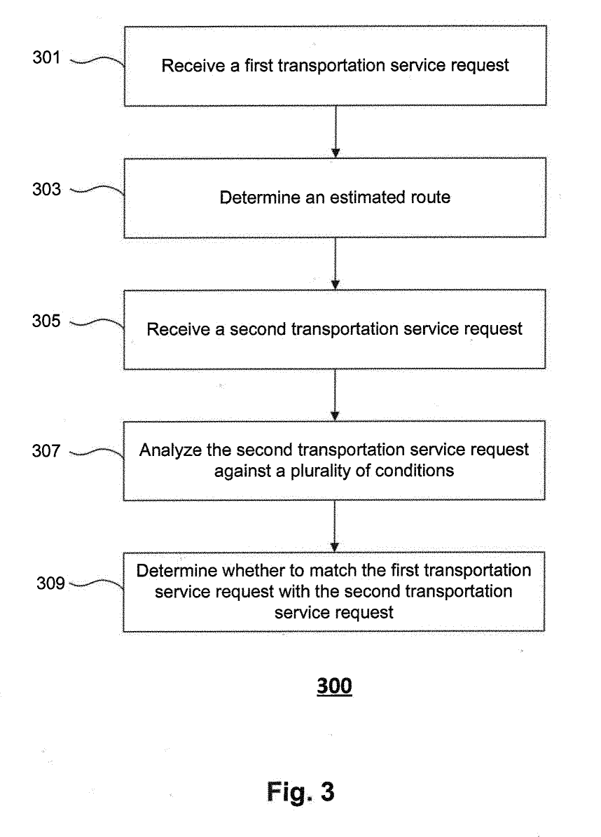

At step 205, time determination unit 108 may determine a hypothetical time for the first transportation service request to be fulfilled if switching to a carpool request. To determine the hypothetical time, request matching unit 106 may match the first transportation service request with a second transportation service request in the queue for carpool service. Request matching unit 106 may determine whether to match the first transportation service request with a second transportation service request by analyzing the first transportation service request against a plurality of conditions. An exemplary method for matching service requests will be discussed in connection with FIG. 3. Time determination unit 108 may determine the hypothetical time based on the position of the second transportation service request in the queue for carpool service. In some embodiments, the hypothetical time may include an estimated wait time for the second transportation service request to be processed and an estimated trip time for fulfilling the second transportation service request using the carpool service.

In some embodiments, the estimated time determined by time, determination unit 108 may be transmitted to the user. Similarly, the hypothetical time, a number of waiting requests before the transportation service request, a total number of requests in the queue, and available vehicles in the region may be transmitted to the user, allowing the users to have enough information to assess the current traffic condition. Particularly, the estimated time can assist the users to use the proper form of transportation to get to the destination, or to plan their schedules accordingly if they decide to wait for the ride as originally requested. On the other hand, the hypothetical time can assist users to decide whether or not to switch to a carpool service.

At step 207, when the hypothetical time is less than the estimated time, processor 104 may provide a recommendation to the user terminal device 120 to switch to a carpool request. A recommendation may increase the likelihood for the user to switch to a carpool request, and in turn, increase the efficiency of carpool service. At step 209, when an acceptance of the recommendation is received from the user terminal device, system 100 may provide a carpool service to fulfill the first transportation service request. Service vehicle 124 or a service provider may receive the carpool service request.

FIG. 3 is a flowchart of an exemplary method 300 for matching two transportation service requests. At step 301, communication interface 102 may receive a first transportation service request from a user terminal device 120. At step 303, based on the first transportation service request, processor 104 may determine an estimated route. Based on the origin and destination, processor 104 may determine a route and store it in memory 112. While determining the estimated route, route generation unit 110 may access map information, traffic information, route determination module, etc.

Similar to step 301, at step 305, communication interface 102 may receive a second transportation service request from another user terminal device 120. At step 307, processor 104 may analyze the second transportation service request against a plurality of conditions: After analysis, processor 104 may assign a true or false value for each condition and store the values in memory 112.

First, in order to increase carpooling efficiency and reduce time cost, processor 104 may limit the increase of trip time due to picking up the second passenger to a threshold time, such as a few minutes. For example, processor 104 may determine a first estimated trip time for fulfilling the first request. After the second transportation service request is received, processor 104 may determine a second estimated trip time, for fulfilling the first and second transportation service requests. In some embodiments, processor 104 may determine a difference between the second estimated trip time and the first estimated trip time. In some other embodiments, processor 104 may determine a ratio of the first estimated trip time to the second estimated trip time. The time difference or the ratio may be compared to a predetermined threshold value, to obtain a true or false determination for the condition. Processor 104 may calculate the time difference/ratio and the true or false value for the condition in memory 112. For example, when the ratio is greater than a pre-determined threshold, processor 104 may assign a true value for the condition, and update the estimated route to accommodate the second carpool request. Otherwise, a false value for the condition will be assigned, and the determined first trip will not be expanded to accommodate the second passenger. For example, the determined first estimated trip time may be 40 minutes and the second estimated trip time may be 80 minutes. If the pre-determined threshold is 50%, then the condition is satisfied and processor 104 may update the predicted route to include the origin and destination of the second transportation service request.

In some embodiments, processor 104 may be configured to assure that the carpool trip route serving both the first and second passengers does not deviate too much from the original trip route serving only the first passenger. For example, route generation unit 110 may first determine a first estimated route based on the origin and destination of the first transportation service request. Route generation unit 110 may then determine a second estimated route to include the origin and destination of the second transportation service request. Request matching unit 106 may determine a degree of matching between the first estimated route and the second estimated route. For example, a high degree of matching may be found when the two routes overlap in most parts. Various algorithms may be used to determine the degree of matching, e.g., calculating entropy of the difference between the two routes, or using a machine learning network trained to determine a degree of matching based on training data. In some embodiments, when the degree of matching is greater than a pre-determined threshold, processing unit 202 may assign a true value for the condition and update the predicted route to accommodate the origin and the destination of the second transportation service request.

In some embodiments, processor 104 may be configured to assure the number of passengers does not exceed the number of passenger seats available in a vehicle. After the first request is received, processor 104 may determine a current capacity in the vehicle based on the total number of seats in the vehicle and the number of requested seats in the first transportation service request. After receiving the second transportation service request, processor 104 may compare the number of requested seats in the second transportation service request with the number of available seats. If the number of passengers of the second transportation service request is less than the number of available seats, processor 104 may assign a true value for the condition and update the estimated route to accommodate the origin and the destination of the second transportation service request.

In some embodiments, to reduce the wait time and increase carpooling efficiency, processor 104 may determine the time difference between receiving both transportation service requests. Processor 104 may start a timer upon receipt of the first transportation service request and stop the timer upon receipt of the second transportation service request. Accordingly, a reading from the timer is the time difference. Alternatively, processor 104 may store in memory 112 a first time stamp upon receipt of the second transportation service request. After the second transportation service request is received, processor 104 may store a second time stamp indicating the receipt time the second transportation service request. The time difference as a difference between the two time stamps. When the difference is no greater than a pre-determined threshold, processor 104 may store a true value for the condition and update the estimated route to accommodate the origin and the destination of the second transportation service request.

At step 309, based on the analysis above, processor 104 may determine whether to match the first transportation service request with the second transportation service request. For example, if all conditions are satisfied, processor 104 may match both transportation service requests.

In some embodiments, to improve carpooling efficiency and to limit the pending time for a request, processor 104 may set a cap for the time difference between receiving the first and second transportation service requests. Furthermore, the cap can be set based on traffic conditions. For example, when in a poor traffic condition, a greater cap may be set. The cap for the time difference between receiving the first and second transportation service requests may be represented in time units, such as minutes, seconds, etc. When a cap is set for 10 minutes, processor 104 may match the first transportation service request with the second transportation service request, only if the time difference is less than 10 minutes.

In some embodiments, to increase carpooling efficiency, processor 104 may send notifications to the users. Specifically, processor 104 may calculate request pending time, starting from the time point when first transportation service request is received. Processor 104 may then determine whether the pending time is greater than the pre-determined value. When the pending time is less than the pre-determined value, processor 104 may add the first transportation service request to the carpool queue waiting for a match. Furthermore, based on the above, processor 104 may generate a request to display carpool notifications, so that the users may be more willing to request for carpooling service.

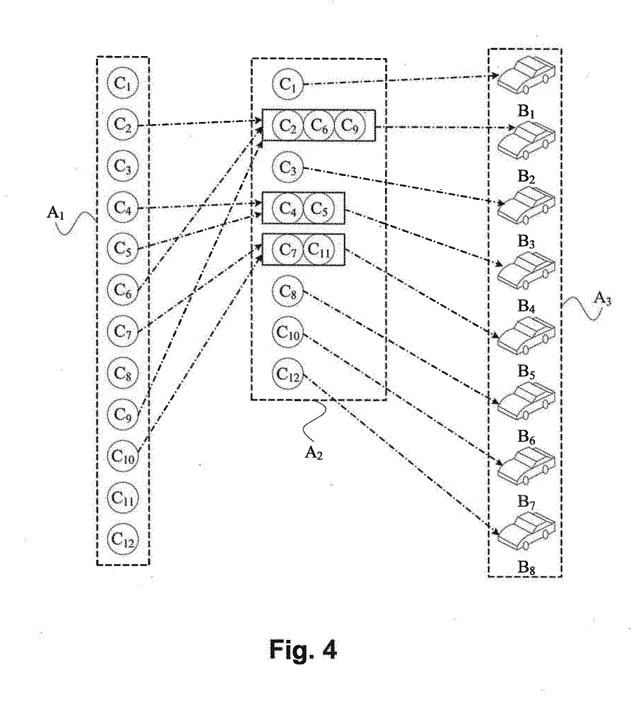

FIG. 4 illustrates an exemplary method 400 for processing simultaneous carpool requests. Section A1 includes multiple carpool requests, C1-C12, from the users. Section A2 shows the grouping of these carpool requests. Section A3 includes multiple vehicles, B1-B8, available to provide transportation service. Processor 104 receives carpool requests C1 to C12 in time order. After the analysis against the plurality of conditions, processor 104 may group the requests for carpooling. For example, carpool requests C2, C6, and C9 may be grouped together and assigned to vehicle B2. Carpool requests C4 and C5 may also be grouped together and assigned to vehicle B4. Carpool requests C7 and C11 may be grouped together and assigned to driver B5. The remaining carpool requests are not grouped and will be assigned to vehicles B1, B3, B6-B8, respectively. As a result, 8 vehicles can fulfill 12 transportation service requests.

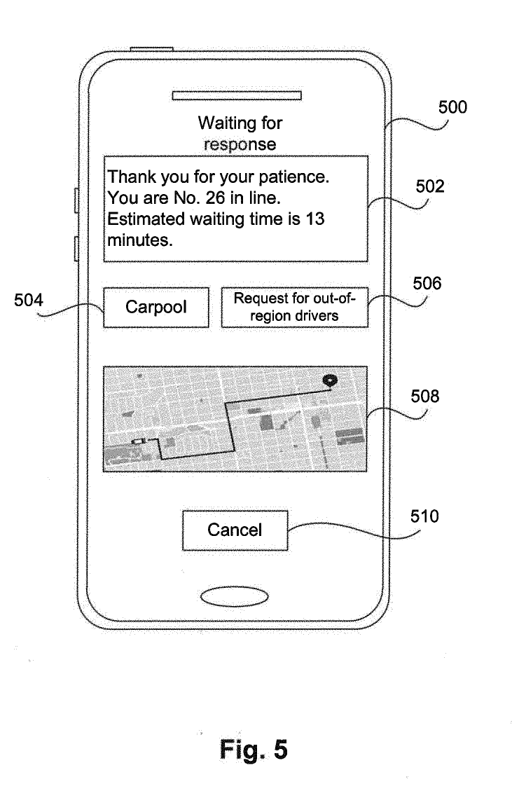

FIG. 5 illustrates an exemplary user interface, consistent with disclosed embodiments. As shown in FIG. 5, an exemplary user interface 500 may include: a notification 502, a carpool request button 504, a “request for out-of-region driver” button 506, a map 508, and a cancel button 510. As described above, when the request pending time is greater than the pre-determined value, user terminal device 120 may be configured to display a notification 502, informing the user of the estimated waiting time, the queue position, the reason for the delay, or any combination thereof. For example, the reason for the delay may be “rush hour”, “poor weather condition”, and/or “traffic accident,” etc. In the example shown by FIG. 5, notification 502 indicates that the user is the 26^{th} in line and the estimated waiting time is 13 minutes. In some embodiments, notification 502 may include a recommendation to switch to a carpool request when the hypothetical time for switching to carpooling is less than the estimated time. The user may press carpool request button 504 to accept the recommendation.

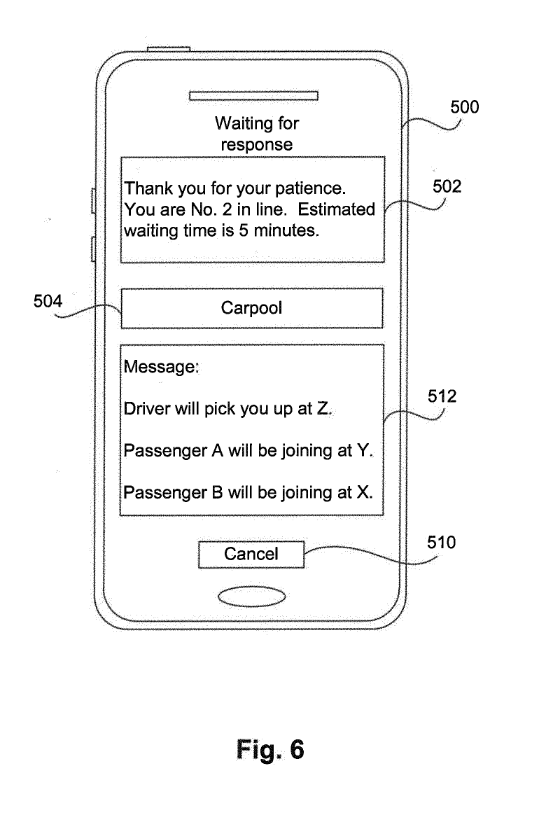

When carpool request button 504 is pressed, exemplary user interface 500 may become what is shown in FIG. 6, consistent with disclosed embodiments. As shown in FIG. 6, notification 502 informs the user that the user becomes the second in line by using carpooling service and the estimated time is 5 minutes. Additionally, carpool notification 512 may be provided to display carpool information to the users. For example, carpool notification 512 may display a carpool itinerary, including the order each passenger will be picked up and dropped off, and the respective pick-up locations and/or drop-off locations.

Referring back to FIG. 5, in some embodiments, instead of requesting for a carpool, the user may alternatively request an out-of-region driver. When “request out-of-region drivers” button 506 is pressed, user terminal device may send a request to expand the request broadcast area in order to dispatch a driver that is out of the original search area.

Map 508 may show the user location, the origin of a transportation service request, driver's location, and estimated route. Map 508 may provide the driver's real time location, so that users may determine how far the driver is and where to meet the driver.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving a first transportation service request from a user terminal device;
determining, by a processor, an estimated time for the first transportation service request to be fulfilled;
determining, by the processor, a hypothetical time for the first transportation service request to be fulfilled if switching to a carpool request;
providing, to the user terminal device, a recommendation to switch to the carpool request when the hypothetical time is less than the estimated time; and
providing a carpool service to fulfill the first transportation service request when an acceptance of the recommendation is received from the user terminal device.

2. The method of claim 1, wherein determining the estimated time further comprises:
placing the first transportation service request in a queue; and
determining the estimated time based on a position of the first transportation service request in the queue.

3. The method of claim 1, wherein the estimated time includes an estimated wait time for the first transportation service request to be processed or an estimated trip time for fulfilling the first transportation service request.

4. The method of claim 2, determining the hypothetical time further comprises:
matching the first transportation service request with a second transportation service request in the queue for a carpool service; and
determining the hypothetical time based on a position of the second transportation service request in the queue.

5. The method of claim 4, wherein the hypothetical time includes an estimated wait time for the second transportation service request to be processed or an estimated trip time for fulfilling the second transportation service request using the carpool service.

6. The method of claim 4, where matching the first transportation service request with the second transportation service request further comprises:
matching the first transportation service request with the second transportation service request, when the difference between the estimated time for the first transportation service request to be fulfilled and the hypothetical time based on a position of the second transportation service request in the queue is no greater than a pre-determined value.

7. The method of claim 4, where matching the first transportation service request with the second transportation service request further comprises:
determining a current capacity; and
matching the first transportation service request with the second transportation service request, when a number of passengers of the second transportation service request is no greater than the current capacity.

8. The method of claim 4, where matching the first transportation service request with the second transportation service request further comprises:
determining an estimated route based on the first transportation service request;
determining a hypothetical route based on the first transportation service request to be fulfilled if switching to a carpool request;
determining a similarity between the estimated route and the hypothetical route; and
matching the first transportation service request with the second transportation service request, when the similarity is greater than a predetermined value.

9. A system for providing transportation service, comprising:
a memory;
a communication interface, configure to:
receive a first transportation service request from a user terminal device; and
at least one processor coupled to the communication interface and the memory, configured to:
determine an estimated time for the first transportation service request to be fulfilled,
determine a hypothetical time for the first transportation service request to be fulfilled if switching to a carpool request,
provide, to a user terminal device, a recommendation to switch to the carpool request when the hypothetical time is less than the estimated time, and
provide a carpool service to fulfill the first transportation service request, when an acceptance of the recommendation is received from the user terminal device.

10. The system of claim 9, wherein the at least one processor is further configured to:
place the first transportation service request in a queue; and
determine the estimated time based on a position of the first transportation service request in the queue.

11. The system of claim 9, wherein the at least one processor is further configured to:
match the first transportation service request with a second transportation service request in the queue for a carpool service; and
determine the hypothetical time based on a position of the second transportation service request in the queue.

12. The system of claim 9, wherein the at least one processor is further configured to:
match the first transportation service request with the second transportation service request, when the difference between the estimated time for the first transportation service request to be fulfilled and the hypothetical time based on a position of the second transportation service request in the queue is no greater than a pre-determined value.

13. The system of claim 9, wherein the at least one processor is further configured to:
determine a current capacity; and
match the first transportation service request with the second transportation service request, when a number of passengers of the second transportation service request is no greater than the current capacity.

14. The system of claim 9, wherein the at least one processor is further configured to:
determine an estimated route based on the first transportation service request;
determine a hypothetical route based on the first transportation service request to be fulfilled if switching to a carpool request;
determine a similarity between the estimated route and the hypothetical route; and
match the first transportation service request with the second transportation service request, when the similarity is greater than a pre-determined value.

15. A non-transitory computer readable medium storing instructions that, when executed, cause at least one processor to perform a method for providing transportation service, the method comprising:
receiving a first transportation service request from a user terminal device;
determining, by a processor, an estimated time for the first transportation service request to be fulfilled;
determining, by the processor, a hypothetical time for the first transportation service request to be fulfilled if switching to a carpool request;
providing, to the user terminal device, a recommendation to switch to the carpool request when the hypothetical time is less than the estimated time; and
providing a carpool service to fulfill the first transportation service request when an acceptance of the recommendation is received from the user terminal device.

16. The method of claim 15, wherein determining the estimated time further comprises:
placing the first transportation service request in a queue; and
determining the estimated time based on a position of the first transportation service request in the queue.

17. The method of claim 16, determining the hypothetical time further comprises:
matching the first transportation service request with a second transportation service request in the queue for a carpool service; and
determining the hypothetical time based on a position of the second transportation service request in the queue.

18. The method of claim 17, where matching the first transportation service request with a second transportation service request further comprises:
matching the first transportation service request with the second transportation service request, when the difference between the estimated time for the first transportation service request to be fulfilled and the hypothetical time based on a position of the second transportation service request in the queue is no greater than a pre-determined value.

19. The method of claim 17, where matching the first transportation service request with a second transportation service request further comprises:
determining a current capacity; and
matching the first transportation service request with the second transportation service request, when a number of passengers of the second transportation service request is no greater than the current capacity.

20. The method of claim 17, where matching the first transportation service request with a second transportation service request further comprises:
determining an estimated route based on the first transportation service request;
determining a hypothetical route based on the first transportation service request to be fulfilled if switching to a carpool request;
determining a similarity between the estimated route and the hypothetical route; and
matching the first transportation service request with the second transportation service request, when the similarity is greater than a pre-determined value.
